(19) United States
(12) Patent Application Publication
(10) Pub. No.: US 2008/0040198 A1
(43) Pub. Date: Feb. 14, 2008

(54) Device and Method for Modeling Electronic Business Transactions

(75) Inventors: Hermann Friedrich, Zorneding (DE); Brigitte Grillmair, Linz (AT); Martin Mitko, Ilmmunster (DE); Gustav Pomberger, Linz (AT); Johannes Sametinger, Linz (AT); Norbert Weber, Moosach (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT, Munchin (DE)

(21) Appl. No.: 11/547,857

(22) PCT Filed: Feb. 1, 2005
(86) PCT No.: PCT/EP05/50434

§ 371 Date: Oct. 6, 2006

(30) Foreign Application Priority Data
Apr. 7, 2004 (DE) 10 2004 017271.4

(51) Int. Cl. G06Q 30/00

(52) U.S. Cl. 705/10

(57) ABSTRACT

A model and a corresponding database are disclosed. This model and/or database can be used for settling, by way of suitable automatic and systematic allocation, the question: which eServices/eSolutions can be used for which business transactions or workflows or vice versa which eServices/eSolutions are suitable for which business transactions or workflows?

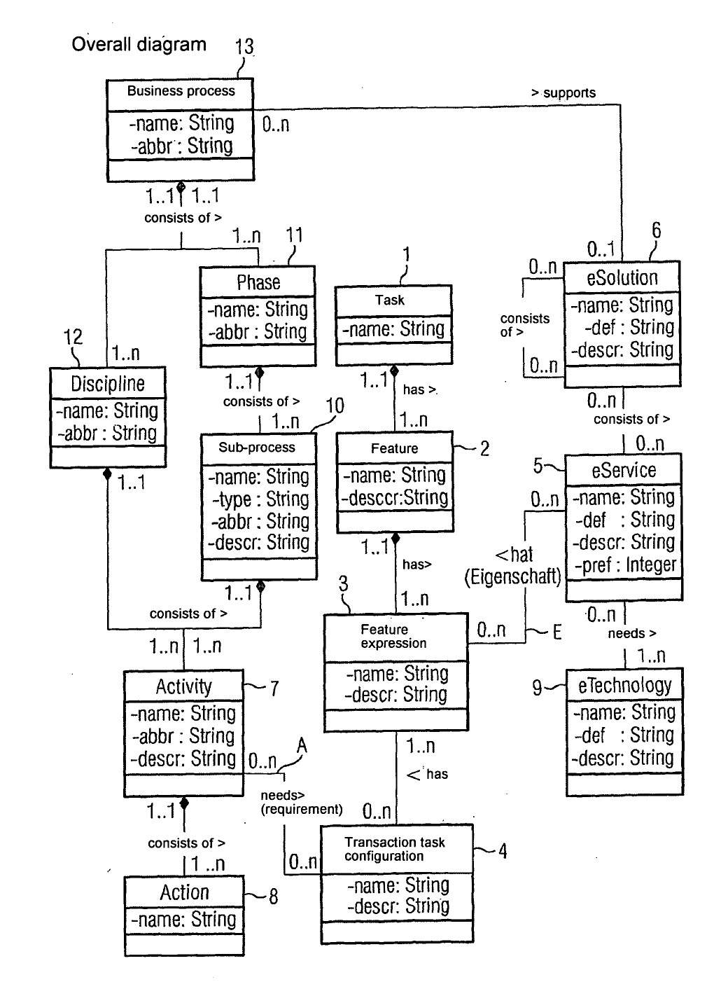

### PRIORITY STATEMENT

This application is the national phase under 35 U.S.C. §371 of PCT International Application No. PCT/EP2005/050434 which has an International filing date of Feb. 1, 2005, which designated the United States of America and which claims priority on German Patent Application number 10 2004 017 271.4 filed Apr. 7, 2004, the entire contents of which are hereby incorporated herein by reference.

### FIELD

The invention generally relates to a device and/or method in which electronic services or solutions, and/or so-called eServices or eSolutions are allocated to business processes, sequence structures and/or associated activities.

### BACKGROUND

A number of terms are used in the text of the description, which are explained in detail and/or defined at this point:

eServices
are services for supporting the time-independent and location-independent handling of business processes by way of Internet technologies for the purposes of achieving specific objectives. These can involve technical, social, and/or economic objectives (e.g. shortening the throughput time, opening up new markets, strengthening customer loyalty, reducing the number of errors). An eService can support the handling of entire business processes, individual business process activities or parts of business process activities. Examples of eServices include Bulletin Board Systems, Chat, eMail, and Newsgroups.
eSolutions
are a combination of mutually coordinated eServices.

### Business Processes

are groupings of activities that are connected in terms of subject matter, which are necessary to process a business event. The individual activities can be dispersed in organizational terms, but usually have temporal and logical dependencies with respect to each other.

### Workflows

are sequence structures within business processes, which describe the information flow between activities that are strongly associated in terms of content, e.g. activities of Project Management or Test Engineering.

By using eBusiness and/or the underlying techniques, such as eServices and eSolutions for example, business processes and in particular development processes can be optimized. To identify and pull out potential systematically, suitable eBusiness techniques must be allocated to the processes and the activities to be carried out. However, the set of eServices and eSolutions already known today, and even that of the activities in a process, is very large nowadays and therefore difficult to allocate.

### SUMMARY

At least one embodiment of the invention is directed to a device and/or method for modeling, in particular, extensive, electronic business transactions, and in the course of this carrying out this allocation efficiently, i.e. being able to determine the suitable eServices and eSolutions in a manner that is coordinated to the individual requirements of every activity.

At least one embodiment is directed to the allocation of eServices or eSolutions to business processes and/or workflows e.g. as per ISO 9000 in a defined and traceable manner, with the result that this allocation is not left to chance or just the empirical knowledge of individuals.

At least one embodiment of the invention resides in the fact that the question of which eServices/eSolutions can be used for which business processes and/or workflows or vice versa which eServices/eSolutions are suitable for which business processes and/or workflows is clarified by way of suitable automatic and systematic allocation with the aid of a model and/or a corresponding database.

### DETAILED DESCRIPTION OF THE EXAMPLE EMBODIMENTS

In the following, an advantageous example embodiment of the invention is explained in more detail on the basis of an overall diagram, where a data model with a requirements and properties catalog is shown among other things, which displays data elements 1, 2, 3, and 4. An automatic allocation of eservices 5 or eSolutions 6 to business processes 13, workflows or associated activities 7 takes place by way of such requirements and properties catalogs. These catalogs are of such a nature that an automatic allocation is possible. The solution of the problem is ensured by way of these catalogs and also the coordination process on the basis of these catalogs.

The requirements catalog represents a systematic compilation of all requirements A with reference to quantitative or qualitative properties, which are required by a business process, workflow or activity for its support.

The properties catalog, on the other hand, represents a systematic compilation of services with reference to quantitative or qualitative properties E, which are ensured by eServices/eSolutions.

The requirements catalog and properties catalog use the same system of description, with the result that a coordination between business processes and/or workflows and eServices/eSolutions is possible in formal terms. This system is based on data elements for tasks 1, which are described by way of features 2 and associated feature expressions 3.

The core items of the method include tasks 1; the following two views apply to their characterization:

From the viewpoint of the business processes and/or workflows, tasks include requirements that one or more activities of the business processes and/or workflows, e.g. Project Management or Payments Administration, have, and that should be supported by means of eServices/eSolutions, such as Cooperation or Coordination for example.

From the viewpoint of the technology, tasks include capabilities of eServices/eSolutions with which business processes and/or workflows can be supported.

As already mentioned, tasks 1 are described by way of features 2. Features 2 include properties of a task that characterize it and distinguish it from other tasks. The property is essential, i.e. it is necessarily attached to the task. A feature is termed a quantitative feature if the feature expression 3 is allocated to a cardinal scale, otherwise it is termed a qualitative feature (ordinal or nominal scale).

A feature expression 3 includes a target value, guide value or actual value. In the present method, every feature has specific feature expressions; they are not arbitrarily definable, therefore.

### Creation of the Catalogs

The requirements catalog and the properties catalog are built up by using this structure, where:

to build up the requirements catalog for every activity of a business process and/or workflow of an organization, its requirements are identified by describing the tasks to be supported with the corresponding features and feature expressions, and where to build up the properties catalog for every available eService/every available eSolution, its capabilities for supporting tasks with specific features and feature expressions are described.

For the purposes of simplifying the creation of requirements catalogs, data elements for transactions 4 are introduced, i.e. configurations of tasks with a specific feature expression. Transactions occur in several activities of a business process. Features and feature expressions therefore only need to be defined once for one transaction and not repeatedly for all activities. It is then sufficient to allocate transactions to the activities and therefore describe their requirements indirectly.

Typically, the catalogs are created once and must then be maintained, e.g. in the case of changes to the business processes, accommodation of new eServices/eSolutions or property changes to eServices/eSolutions.

### Coordination of the Catalogs

A set of potential eServices for a business process can be determined by way of coordination between the requirements catalog and the properties catalog. The eServices include those eServices that come into consideration in principle for supporting a business process. In this respect, different eServices will typically be available for selection for each transaction and/or feature expression.

The requirements of an activity are present in the form of transactions. Every transaction is described by way of feature expressions. An eService comes into consideration as support for a transaction if it displays all the feature expressions of said transaction as properties. If a single property is missing, an eService does not come into consideration. If an eService has additional properties that are not necessary for a transaction, this has no effect.

During the coordination of the catalogs, potential eServices are allocated to the activities. In this respect, the eServices come into consideration as support for one or more transactions in each case. For each transaction, there will be no, one or several eServices available for selection.

It is not worthwhile to employ all potential eServices for one activity. A subset must therefore be selected from the potential eServices for the support of an activity, which supports all transactions as a whole. There will frequently be several possibilities for this.

In principle, there are different procedures for selecting one possibility out of several. An attempt can be made, for example, to manage with as few eServices as possible. An attempt can also be made to select specific eServices on an a priori basis, e.g. those that are already available and satisfy requirements not yet covered with further eServices. If several eServices are available for selection, attention should furthermore be paid to the fact that the same selection is always made in the case of different activities of a business process.

### Data Model

For the purposes of a technical implementation, both the structure of business processes and their requirements, and also eServices/eSolutions for supporting business processes together with their properties, must be modeled. This data model forms the basis for the implementation of a tool, which allocates eServices/eSolutions to the activities of business processes/workflows. The precise modeling of the business processes and eServices/eSolutions is not so important for the invention; the primary issue is the modeling of the requirements and properties catalogs, which must be of such a nature that an automatic coordination is possible.

As already mentioned, both requirements and properties are described by way of expressions of various features, thereby enabling an automatic coordination. The features are grouped with respect to different tasks. The properties of eServices/eSolutions are described directly by means of the specification of feature expressions. In the case of requirements, feature expressions of transactions are grouped together since the expressions of every transaction must be present as a whole as the properties of a potential eService.

Business processes and eServices/eSolutions can be modeled differently. What is important, however, is that properties are described by using feature expressions and requirements by using transactions. The drawing shows a complete data model, in which business processes 13 are modeled by means of phases 11, sub-processes 10, activities 7, and actions 8; and also eSolutions 6 by using eServices 5 implemented by means of eTechnologies 9.

### Selection Method

Different strategies can be applied to select a subset from the potential eServices. A possible procedure is described in the following.

### Step 1: Specify Preferences for eServices

In the case of automated selection of eServices, several candidates come into consideration as a rule. To improve automated selection, a selection preference is specified for every eService in the first step. Possible preferences include:
1: Never consider eService
3: Consider eService where relevant
5: Consider eService where possible
7: Always consider eService

The preferences can be set individually prior to every coordination process or adapted once to the circumstances of the organization and then applied during further coordination processes in unchanged form. The preferences can be selected according to price and safety, for example, in this respect.

### Step 2: Determine Potential eServices for Every Transaction

The feature expressions of every transaction are compared with the properties of the eServices. In the case of a full match, an eService is selected as a candidate.

### Step 3: Selection in the Case of Several eService Candidates

If several eServices come into consideration for the purposes of supporting a transaction, the selection is performed as defined by the preferences in step 1. If an eService with the preference 7 comes into consideration, for example, then eServices with the preferences 5, 3, and 1 are excluded. If several eServices with the same preference come into consideration, then selection is enabled for the user. Step 4: Determine Potential eServices for Activity

If the potential eServices are determined for all transactions of an activity, potential eServices for the overall activity can be determined from this. They result from the total of all eServices of the transactions that belong to the activity.

### Step 5: Eliminate Redundancies

Redundancies can occur in the case of the eServices determined in steps 3 and 4. One eService can cover several transactions, for example. Those eServices that only cover a part of said transactions, e.g. only one single transaction, therefore become superfluous. These eServices are excluded from the selection.

### Step 6: Make Definitive Selection

All selected eServices are displayed to the expert for the purposes of definitive interactive selection for every activity.

### Step 7: Determine Potential eServices for Business Process

If the eServices for all activities of a business process are known, then its support by way of eServices can easily be determined by means of “summation” and/or by way of building up the union of sets.

### Application Example

In this example, eServices are determined for the purposes of supporting the activity “Create software development test plan”. To do this, the properties catalog of all eServices must be coordinated with the requirements catalog for this activity. The coordination is restricted to the tasks of Communication and Coordination, so as not to allow the scope of the documentation to become too large.

1st Step—List Feature Expressions

For the purposes of creating a software development test plan, it is necessary that each two participants exchange information about their respective areas directly and in fact in an asynchronous manner, and that one or more meetings take place in which all participants communicate simultaneously. Furthermore, the coordination of dates for meetings and document handovers must be supported. This results in the following feature expressions:

### Activity Create Software Development Test Plan SW 05

| | Feature | | Feature expression | |
|---|---|---|---|---|
| | Communication | | | |
| Task | 1 | Communication type | 1 | Direct |
| | 1 | Communication type | 3 | Synchronous |
| | 1 | Communication type | 4 | Asynchronous |
| | 2 | Direction of message flow | 6 | Bidirectional |
| | 3 | Association | 7 | 1:1 |
| | 3 | Association | 10 | N:M |
| | 4 | Frequency of message exchange | 11 | Daily |
| | Coordination | | | |
| Task | 6 | Number of participants | 17 | Several |
| | 7 | Subject | 18 | Documents |
| | 7 | Subject | 19 | Dates |
| | 8 | Distribution of participants | 21 | Within team |
| | 8 | Distribution of participants | 22 | Within enterprise |

2nd Step—Allocate eServices

For every feature expression of the activity established in step 1, those eServices that display a corresponding property are listed.

| | | |
|---|---|---|
| Communication | 1 Communication type 1 | Direct |

| | |
|---|---|
| 4 | Chat |
| 10 | eMail |
| 13 | IP Telephony |
| 17 | Newsletter |
| 24 | Video Conference |

| | | |
|---|---|---|
| Communication | 1 Communication type 3 | Synchronous |

| | |
|---|---|
| 4 | Chat |
| 13 | IP Telephony |
| 24 | Video Conference |

| | | |
|---|---|---|
| Communication | 1 Communication type 4 | Asynchronous |

| | |
|---|---|
| 2 | Banner |
| 3 | Bulletin Board System |
| 10 | eMail |
| 14 | Location Based Services |
| 16 | Newsgroup |
| 17 | Newsletter |
| 19 | Online Catalog |

| | | |
|---|---|---|
| Communication | 2 Direction of message flow 6 | Bidirectional |

| | |
|---|---|
| 3 | Bulletin Board System |
| 4 | Chat |
| 10 | eMail |
| 13 | IP Telephony |
| 16 | Newsgroup |
| 24 | Video Conference |

| | | |
|---|---|---|
| Communication | 3 Association of communication partners 7 | 1:1 |

| | |
|---|---|
| 4 | Chat |
| 10 | eMail |
| 13 | IP Telephony |

| | | |
|---|---|---|
| Communication | 3 Association of communication partners 10 | N:M |

| | |
|---|---|
| 3 | Bulletin Board System |
| 4 | Chat |
| 16 | Newsgroup |
| 24 | Video Conference |

| | | |
|---|---|---|
| Communication | 4 Frequency of message exchange 11 | Daily |

| | |
|---|---|
| 3 | Bulletin Board System |
| 4 | Chat |
| 10 | eMail |
| 13 | IP Telephony |
| 16 | Newsgroup |
| 24 | Video Conference |

| | | |
|---|---|---|
| Coordination | 6 Number of participants 17 | Several |

| | |
|---|---|
| 1 | Account |
| 18 | Online Auction |
| 19 | Online Catalog |

| | | |
|---|---|---|
| Coordination | 7 Subject 18 | Documents |

| | |
|---|---|
| 1 | Account |
| 8 | Digital Signature |

| | | |
|---|---|---|
| Coordination | 7 Subject 19 | Dates |
| Coordination | 8 Distribution of participants 21 | Within team |
| Coordination | 8 Distribution of participants 22 | Within enterprise |

| | |
|---|---|
| 1 | Account |

3rd Step—Check Completeness

Two feature expressions occur in the requirements catalog with respect to which no eService exists with the corresponding properties. For the sake of simplicity and on the assumption that these requirements do not have to be supported by using eService in the first instance, this is ignored.

4th Step—Select eServices

Different approaches are possible for the selection of the eServices. Two simple ones are outlined in the following.

### Approach 1: Selection of the First eService in Each Case:

The first eService is simply selected in the case of every feature expression. In this example, this results in the following set of eServices for the specified feature expressions.

### Activity Create Software Development Test Plan SW 05

| | Feature | | Feature expression | | eService |
|---|---|---|---|---|---|
| | Communication | | | | |
| Task | 1 | Communication type | 1 | Direct | [symbol] Chat |
| | 1 | Communication type | 3 | Synchronous | [symbol] Chat |
| | 1 | Communication type | 4 | Asynchronous | [symbol] Banner |
| | 2 | Direction of message flow | 6 | Bidirectional | [symbol] Bulletin Board S. |
| | 3 | Association | 7 | 1:1 | [symbol] Bulletin Board S. |
| | 3 | Association | 10 | N:M | [symbol] Bulletin Board S. |
| | 4 | Frequency of message exchange | 11 | Daily | [symbol] Bulletin Board S. |
| | Coordination | | | | |
| Task | 6 | Number of participants | 17 | Several | [symbol] Account |
| | 7 | Subject | 18 | Documents | [symbol] Account |
| | 7 | Subject | 19 | Dates | [symbol] — |
| | 8 | Distribution of participants | 21 | Within team | [symbol] — |
| | 8 | Distribution of participants | 22 | Within enterprise | [symbol] Account |

All requirements can be covered with only four eServices. Alphabetical order was the sole determining factor for the selection, however. In the following, these eServices are listed with those properties that are important for the activity “Create software development test plan”.

Account

| | | | | |
|---|---|---|---|---|
| Coordination | 6 | Number of participants | 17 | Several |
| | 7 | Subject | 18 | Documents |
| | 8 | Distribution of participants | 22 | Within |
| | | | | enterprise |

Banner

| | | | | |
|---|---|---|---|---|
| Communication | 1 | Communication type | 4 | Asynchronous |

Bulletin Board System

| | | | | |
|---|---|---|---|---|
| Communication | 2 | Direction of message flow | 6 | Bidirectional |
| | 3 | Association | 7 | 1:1 |
| | 3 | Association | 10 | N:M |
| | 4 | Frequency of message | 11 | Daily |
| | | exchange | | |

Chat

| | | | | |
|---|---|---|---|---|
| Communication | 1 | Communication type | 1 | Direct |
| | 1 | Communication type | 3 | Synchronous |

The eService Chat also supports 1:1 communication. This property is irrelevant after this eService selection since it is already supported by way of the eService Bulletin Board System.

Result: The eServices Account, Chat, Banner, and Bulletin Board System are selected.

### Approach 2: Minimization of the number of eServices

The eServices are initially ordered according to the number of feature expressions that they display. For the task Communication, these include:

| | Number of feature |
|---|---|
| eService | expressions supported |
| Chat | 6 |
| eMail | 5 |
| IP Telephony | 5 |
| Video Conference | 5 |
| Bulletin Board System | 4 |
| Newsgroup | 4 |
| Newsletter | 2 |
| Banner | 1 |
| Online Catalog | 1 |

The eServices are selected in this order, and in fact until all requirements are satisfied. The eService Chat satisfies six out of seven properties of the task Communication.

Chat

| | | | | |
|---|---|---|---|---|
| Communication | 1 | Communication type | 1 | Direct |
| | 1 | Communication type | 3 | Synchronous |
| | 2 | Direction of message flow | 6 | Bidirectional |
| | 3 | Association | 7 | 1:1 |
| | 3 | Association | 10 | N:M |
| | 4 | Frequency of message | 11 | Daily |
| | | exchange | | |

For the feature expression not yet covered, the first eService in order that displays that feature expression is selected. In this case, this is true of eMail:

eMail

| | | | | |
|---|---|---|---|---|
| Communication | 1 | Communication type | 4 | Asynchronous |

For the task Coordination, this results in the following ordering:

| | Number of feature |
|---|---|
| eService | expressions supported |
| Account | 3 |
| Digital Signature | 1 |
| Online Auction | 1 |
| Online Catalog | 1 |

The eService Account is selected since it displays the most feature expressions. It covers all feature expressions, due to which no further eService is necessary.

Account

| | | | | |
|---|---|---|---|---|
| Coordination | 6 | Number of participants | 17 | Several |
| | 7 | Subject | 18 | Documents |
| | 8 | Distribution of participants | 21 | Within team |

Result: The eServices Account, Chat, and eMail are selected.

5th step—Adaptation of the Results

How the decision between several suitable eServices is to be made is dependent on the priorities of the process owner. One possibility resides in considering eServices that are already present or widely distributed.

According to Approach 1, the following eServices were selected:
Account
Chat
Banner
Bulletin Board System

This result is rather unsatisfactory because several eServices were selected that cover the same feature expressions (redundancy), and because an eService “Banner” occurs that admittedly supports a required feature expression but also possesses several “unwanted” properties, specifically indirect communication and unidirectional communication, and is therefore not adequate.

According to Approach 2, the following eServices were selected:

### Account

### Chat

eMail

This result represents an improvement compared to Approach 1 because it was possible to reduce the number of eServices required.

Whether, and if so what, changes to this result are necessary or worthwhile is dependent on the situation existing in practice.

### Advantages

The device according to at least one embodiment of the invention supports the optimization of business processes, e.g. by increasing the effectiveness and cost-effectiveness of business process activities by systematically establishing the available potential that consists in the application of proven eServices and eSolutions.

The existing know-how about eServices and eSolutions, in particular with regard to its contribution to the optimization of process activities modeled in the form of properties, is hereby managed and processed systematically.

The allocation of eServices and eSolutions to activities of a business process takes place automatically and does not have to be carried out laboriously by hand, insofar as this can still be done at all with reasonable effort and a sufficiently low number of errors.

Deficiencies with regard to effective eBusiness support for business processes with non-satisfied requirements are identified systematically.

Investment decisions for eServices and eSolutions are supported because it can be simply determined whether, and if so where, improvements can be obtained with their help in business processes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. Device for modeling electronic business transactions, comprising:
at least one requirements catalog and at least one properties catalog, to automatically allocate at least one of electronic services and solutions to at least one of business processes, sequence structures and associated activities,
a requirements catalog including a systematic compilation of all requirements with reference to at least one of quantitative and qualitative properties of a respective at least one of business process, sequence structure and associated activity,
a properties catalog including a systematic compilation of services with reference to at least one of quantitative and qualitative properties, ensured by at least one of electronic services and solutions, and
the requirements catalog and properties catalogs using the same system of description, where both expressions and properties are described by way of associated feature expressions in such a way that a coordination between the business processes and sequence structures is possible in formal terms with the aid of at least one of electronic services and solutions.

2. Device according to claim 1, wherein the properties of the at least one of electronic services and solutions are described directly by way of feature expressions and are described by using transactions, which represent requirements of at least one of business processes, sequence structures and associated activities.

3. Method for modeling electronic business transactions, comprising:
specifying preferences for electronic services;
determining potential electronic services for every transaction, where feature expressions of every transaction are compared with the properties of the electronic services and in the case of a full match, an electronic service is selected as a candidate;
making a selection from several candidates for electronic services, where the selection is performed as defined by the specified preferences and a candidate with the highest priority is selected to the extent that different priorities exist, wherein a selection by the user is otherwise enabled;
determining potential electronic services for all transactions of a respective activity;
eliminating redundancies by excluding those electronic services that only cover a part of another electronic service from the selection;
making a definitive selection, where all selected electronic services are displayed to the expert for the purposes of definitive selection for every activity; and
determining potential electronic services for a respective business process by grouping electronic services for all activities of a business process together.

4. Method according to claim 3, wherein, in the step of specifying, a selection is made from the following preference list:
1: never consider electronic service,
3: consider electronic service where relevant,
5: consider electronic service where possible, and
7: always consider electronic service.

5. Device for modeling electronic business transactions, comprising:
means for specifying preferences for electronic services;
means for determining potential electronic services for every transaction, where feature expressions of every transaction are compared with the properties of the electronic services and in the case of a full match, an electronic service is selected as a candidate;
means for making a selection from several candidates for electronic services, where the selection is performed as defined by the specified preferences and a candidate with the highest priority is selected to the extent that different priorities exist, wherein a selection by the user is otherwise enabled;
means for determining potential electronic services for all transactions of a respective activity;
means for eliminating redundancies by excluding those electronic services that only cover a part of another electronic service from the selection;
means for making a definitive selection, where all selected electronic services are displayed to the expert for the purposes of definitive selection for every activity; and
means for determining potential electronic services for a respective business process by grouping electronic services for all activities of a business process together.

6. Device according to claim 5, wherein, in the means for specifying, a selection is made from the following preference list:
1: never consider electronic service,
3: consider electronic service where relevant,
5: consider electronic service where possible, and
7: always consider electronic service.
